(19) United States
(12) Patent Application Publication
(10) Pub. No.: US 2026/0257686 A1
(43) Pub. Date: Sep. 3, 2026

(54) A CONTROL SYSTEM AND METHOD

(71) Applicant: HORIBA MIRA LIMITED, Nuneaton Warwickshire (GB)

(72) Inventor: Richard Blachford, West Midlands (GB)

(73) Assignee: HORIBA MIRA LIMITED, Nuneaton Warwickshire, GB (GB)

(21) Appl. No.: 18/876,083

(22) PCT Filed: Jun. 16, 2023
(86) PCT No.: PCT/GB2023/051579

§ 371 Date: Dec. 17, 2024

(30) Foreign Application Priority Data
Jun. 17, 2022 (GB) 2208966.8

(51) Int. Cl. B60W 50/00; B60W 60/00

(52) U.S. Cl. CPC B60W 50/0098; B60W 60/001; B60W 2050/006; B60W 2520/06; B60W 2530/18; B60W 2552/30

(57) ABSTRACT

A system and method of controlling a vehicle, the method including: providing waypoint data for a series of waypoints to a path controller; using the path controller to determine interpolation point data for a series of interpolation points defining a target path for the vehicle by interpolating between the waypoints; and controlling the vehicle such that the vehicle follows the target path, wherein the waypoint data includes position data and at least one of heading data, curvature data, and/or inflection data, or wherein the waypoint data includes position data and the method includes using the path controller to determine at least one of heading data, curvature data, and/or inflection data using the waypoint data, wherein curvature data represents heading data differentiated with respect to distance travelled and inflection data represents curvature data differentiated with respect to distance travelled.

### CROSS-REFERENCE TO RELATED APPLICATIONS

This application is a national stage application filed under 35 U.S.C. § 371 of International Patent Application No. PCT/GB2023/051579, filed Jun. 16, 2023, which claims priority to GB 2208966.8, filed Jun. 17, 2022, the entire disclosures of which are incorporated by reference herein.

### FIELD

The disclosure relates to a control system and method which may be used for controlling the movement of a vehicle. The present disclosure may, therefore, be used to control the movement of an autonomous vehicle (e.g. self-driving car).

### BACKGROUND

Autonomous vehicles, particularly self-driving cars, are at the forefront of the automotive revolution.

It may be important to ensure that autonomous vehicles behave in a manner that is both safe and comfortable for human passengers and nearby people. Furthermore, it may be preferable to minimize wear and tear on the vehicle.

Problems with traditional vehicle control systems and methods may include a tendency to produce jerky steering movements, particularly at low speed. This may be both dangerous and unsettling for human passengers and nearby people, and may lead to unnecessary wear and tear on the steering system.

### BRIEF SUMMARY

In some embodiments, the disclosed technology may include a method of controlling a vehicle, the method including: providing waypoint data for a series of waypoints to a path controller; using the path controller to determine interpolation point data for a series of interpolation points defining a target path for the vehicle by interpolating between the waypoints; and controlling the vehicle such that the vehicle follows the target path, wherein the waypoint data includes position data and at least one of heading data, curvature data, and/or inflection data, or wherein the waypoint data includes position data and the method includes using the path controller to determine at least one of heading data, curvature data, and/or inflection data using the waypoint data, wherein curvature data represents heading data differentiated with respect to distance travelled and inflection data represents curvature data differentiated with respect to distance travelled.

The waypoint data may include position data, heading data, curvature data, and inflection data.

The interpolation point data may include interpolation position data and at least one of interpolation heading data, interpolation curvature data, and/or interpolation inflection data.

The interpolation point data may include interpolation position data, interpolation heading data, interpolation curvature data, and interpolation inflection data.

The path controller may determine the interpolation point data using an equation of the form:

$$r ( {n}_{par} ) = {r}_{waypoint w} + {r}_{norm} {\int }_{waypoint w}^{waypoint w + 1} integrand {dn}_{par}$$

where r represents the position of the interpolation point, nₚₐᵣ represents a panametric variable proportional to the distance travelled from the waypoint w towards the waypoint w+1, r_{waypoint} w represents the position of the waypoint w, rₙₒᵣₘ represents a constant, waypoint w and waypoint w+1 represent the waypoints being interpolated between; and integrand represents the integrand. r may represent the position of the interpolation point as a complex number, r_{waypoint w} may represent the position of the waypoint w as a complex number, and rₙₒᵣₘ may represent a complex constant.

In some embodiments, the path controller may determine the interpolation point data using an equation of the form:

$$r ( {n}_{par} ) = {r}_{waypoint w} + {r}_{norm} {\int }_{waypoint w}^{waypoint w + 1} {e}^{i ( polynomial )} {dn}_{par}$$

where polynomial represents a polynomial of the form:

$${n}_{coeff , p} {n}_{par}^{p} + {n}_{coeff , p - 1} {n}_{par}^{p - 1} + … + {n}_{coeff , 1} {n}_{par}$$

where n_{coeff,p} . . . n_{coeff,1} represent constants and p represents the degree of the polynomial.

n_{coeff,p} . . . n_{coeff,1} may represent real constants.

The degree of the polynomial may be 6.

The path controller may determine the interpolation point data using a matrix inversion technique.

The path controller may determine the interpolation point data using matrices of the general form:

$$[ \begin{matrix}\begin{matrix}{a}_{1} \\ ⋮\end{matrix} \\ {a}_{x}\end{matrix} ] = A [ \begin{matrix}\begin{matrix}{n}_{coeff , 1} \\ ⋮\end{matrix} \\ {n}_{coeff , p}\end{matrix} ]$$

where each of the terms a₁ . . . aₓ include rₙₒᵣₘ, and where A represents a matrix that is a function of the limits of nₚₐᵣ.

In some embodiments, the path controller may determine the interpolation point data by: assigning a value to rₙₒᵣₘ; determining the coefficients n_{coeff,1} . . . n_{coeff,p} using the inverse matrix A-1 using matrices of the general form:

$$[ \begin{matrix}\begin{matrix}{n}_{coeff , 1} \\ ⋮\end{matrix} \\ {n}_{coeff , p}\end{matrix} ] = {A}^{- 1} [ \begin{matrix}\begin{matrix}{a}_{1} \\ ⋮\end{matrix} \\ {a}_{x}\end{matrix} ]$$

determining the heading, curvature, and inflection of each interpolation point using the determined coefficients; determining the position of each interpolation point by substituting the determined coefficients into the polynomial; determining the error in position between the final interpolation point and waypoint w+1; and assigning a new value to rₙₒᵣₘ to reduce the error and repeating the process until at least one termination criterion is met.

The error in position between the final interpolation point and waypoint w+1 may be determined as a complex error.

The path controller may determine the interpolation point data using matrices of the general form:

$$[ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ] = A [ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ]$$

The path controller may determine the interpolation point data by: assigning a value to rₙₒᵣₘ; determining the coefficients n_{coeff,1} . . . n_{coeff,p} using the inverse matrix A⁻¹ using matrices of the general form:

$$[ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ] = {A}^{- 1} [ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ]$$

determining the heading, curvature, and inflection of each interpolation point using the determined coefficients; determining the position of each interpolation point by substituting the determined coefficients into the polynomial; determining the error in position between the final interpolation point and waypoint w+1; and assigning a new value to rₙₒᵣₘ to reduce the error and repeating the process until a termination criterion is met.

The error in position between the final interpolation point and waypoint w+1 may be determined as a complex error.

The termination criterion may include a predetermined number of repetitions.

In some embodiments, the disclosed technology may also include a system for controlling a vehicle, the system including: a non-transitory computer-readable storage medium; and a path controller operably coupled to the storage medium, wherein the path controller may be configured to obtain waypoint data for a series of waypoints from the storage medium and to determine interpolation point data for a series of interpolation points defining a target path for the vehicle by interpolating between the waypoints, wherein the path controller may be configured to control the vehicle such that the vehicle follows the target path, wherein the waypoint data includes position data and at least one of heading data, curvature data, and/or inflection data, or wherein the waypoint data includes position data and the method includes using the path controller to determine at least one of heading data, curvature data, and/or inflection data using the waypoint data wherein the curvature data represents heading data differentiated with respect to distance travelled and the inflection data represents curvature data differentiated with respect to distance travelled.

The waypoint data may include position data, heading data, curvature data, and inflection data.

The interpolation point data may include interpolation position data and at least one of interpolation heading data, interpolation curvature data, and/or interpolation inflection data.

The interpolation point data may include interpolation position data, interpolation heading data, interpolation curvature data, and interpolation inflection data.

The path controller may be configured to determine the interpolation point data using an equation of the form:

$$r ( {n}_{par} ) = {r}_{waypoint w} + {r}_{norm} {\int }_{waypoint w}^{waypoint w + 1} integrand {dn}_{par}$$

where r represents the position of the interpolation point, nₚₐᵣ represents a parametric variable proportional to the distance travelled from the waypoint w towards the waypoint w+1, r_{waypoint w} represents the position of the waypoint w, rₙₒᵣₘ represents a constant, waypoint w and waypoint w+1 represent the waypoints being interpolated between; and integrand represents the integrand.

r may represent the position of the interpolation point as a complex number, r_{waypoint w} may represent the position of the waypoint w as a complex number, and rₙₒᵣₘ may represent a complex constant.

The path controller may be configured to determine the interpolation point data using an equation of the form:

$$r ( {n}_{par} ) = {r}_{waypoint w} + {r}_{norm} {\int }_{waypoint w}^{waypoint w + 1} {e}^{i ( polynomial )} {dn}_{par}$$

where polynomial represents a polynomial of the form:

$${n}_{coeff , p} {n}_{par}^{p} + {n}_{coeff , p - 1} {n}_{par}^{p - 1} + … + {n}_{coeff , 1} {n}_{par}$$

where n_{coeff,p} . . . n_{coeff,1} represent constants and p represents the degree of the polynomial.

n_{coeff,p} . . . n_{coeff,1} may represent real constants.

The degree of the polynomial may be 6.

The path controller may be configured to determine the interpolation point data using a matrix inversion technique.

The path controller may be configured to determine the interpolation point data using matrices of the general form:

$$[ \begin{matrix}\begin{matrix}{a}_{1} \\ ⋮\end{matrix} \\ {a}_{x}\end{matrix} ] = A [ \begin{matrix}\begin{matrix}{n}_{coeff , 1} \\ ⋮\end{matrix} \\ {n}_{coeff , p}\end{matrix} ]$$

where each of the terms a₁ . . . aₓ include rₙₒᵣₘ, an w ere A represents a matrix that is a function of the limits of nₚₐᵣ.

In some embodiments, the path controller may be configured to determine the interpolation point data by: assigning a value to rₙₒᵣₘ; determining the coefficients n_{coeff,1} . . . n_{coeff,p} using the inverse matrix A⁻¹ using matrices of the general form:

$$[ \begin{matrix}\begin{matrix}{n}_{coeff , 1} \\ ⋮\end{matrix} \\ {n}_{coeff , p}\end{matrix} ] = {A}^{- 1} [ \begin{matrix}\begin{matrix}{a}_{1} \\ ⋮\end{matrix} \\ {a}_{x}\end{matrix} ]$$

determining the heading, curvature, an inflection of each interpolation point using the determined coefficients; determining the position of each interpolation point by substituting the determined coefficients into the polynomial; determining the error in position between the final interpolation point and waypoint w+1; and assigning a new value to rₙₒᵣₘ to reduce the error and repeating the process until at least one termination criterion is met.

The error in position between the final interpolation point and waypoint w+1 may be determined as a complex error.

The path controller may be configured to determine the interpolation point data using matrices of the general form:

$$[ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ] = A [ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ]$$

The path controller may be configured to determine the interpolation point data by: assigning a value to rₙₒᵣₘ; determining the coefficients n_{coeff,1} . . . n_{coeff,p} using the inverse matrix A⁻¹ using matrices of the general form:

$$[ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ] = {A}^{- 1} [ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ]$$

determining the heading, curvature, and inflection of each interpolation point using the determined coefficients; determining the position of each interpolation point by substituting the determined coefficients into the polynomial; determining the error in position between the final interpolation point and waypoint w+1; and assigning a new value to rₙₒᵣₘ to reduce the error and repeating the process until a termination criterion is met.

The error in position between the final interpolation point and waypoint w+1 may be determined as a complex error.

The termination criterion may include a predetermined number of repetitions.

In some embodiments, the disclosed technology may also include a computer program product or computer-readable storage medium comprising instructions which, when executed by a computer, may cause the computer to carry out the above method.

In some embodiments, the disclosed technology may also include a method of generating a map, the method comprising: generating, using a processor, waypoint data for a series of waypoints; determining, using a processor, interpolation point data for a series of interpolation points defining a target path by interpolating between the waypoints; and storing the target path in a computer-readable non-transitory storage medium, wherein the waypoint data includes position data and at least one of heading data, curvature data, and/or inflection data, wherein curvature data represents heading data differentiated with respect to distance travelled and inflection data represents curvature data differentiated with respect to distance travelled.

The map may be a map for an autonomous vehicle and the target path may be a target path for the vehicle.

### BRIEF DESCRIPTION OF THE FIGURES

In order that the present disclosure may be more readily understood, embodiments thereof will now be described, by way of example only, with reference to the accompanying drawings, in which:

FIG. 1 is a schematic illustration of a vehicle;

FIG. 2 is a schematic illustration of an on-board computer system;

FIG. 3 is a schematic illustration of a remote device;

FIG. 4 is a schematic illustration of a target path; and

FIGS. 5a-d show schematic illustrations of an error correction technique.

### DETAILED DESCRIPTION OF THE DISCLOSURE

In some embodiments, the disclosed technology may include a control system 1 and method, which may be used to control a vehicle 12.

The vehicle 12 may be any kind of vehicle including but not limited to land-based vehicles (e.g. cars, trucks, lorries, motorcycles, heavy plant machinery etc.), water-based vehicles (e.g. ships, boats, submarines etc.) or air-based vehicles (e.g. aeroplanes, helicopters, hovercraft etc.). In some versions the vehicle 12 may be a car.

In some embodiments, the vehicle 12 may include an on-board computer system 121. The on-board computer system 121 may include a non-transitory computer-readable storage medium 127. The on-board computer system 121 may control one or more aspects of the vehicle 12, including one or more aspects of the movement of the vehicle 12. The on-board computer system 121 may include a vehicle control module 122 such as an adaptive cruise control module, advanced driver-assistance system module, and/or autonomous driving module, for example (see e.g. FIG. 2). The vehicle control module 122 may control the movement of the vehicle 12 and may control the direction of travel of the vehicle 12. The vehicle 12 may, therefore, be an autonomous or semi-autonomous vehicle 12 (e.g. a self-driving car).

In some embodiments, the control system 1 may include a remote device 20. The remote device 20 may include any kind of computing device, including for example a desktop or laptop computer, a server, a mobile computing device, a tablet, a cloud computing device, etc. The remote device 20 may include a non-transitory computer-readable storage medium 127. The remote device 20 may be communicatively coupled to the on-board computer system 121 by a wired or wireless communications link. The remote device 20 may be communicatively coupled to the on-board computer system 121 directly and/or via a network 21, such as a cellular network for example (e.g. 3G, 4G, 5G, 6G, LTE etc.).

In some embodiments, the remote device 20 may include the vehicle control module 122 (see e.g. FIG. 3). The vehicle control module 122 may therefore be located remotely from the vehicle 12 but may nevertheless control the movement of the vehicle 12. The vehicle control module 122 may, for example, be a cloud-based vehicle control module 122.

The vehicle 12 may include a steering arrangement 124 that may be configured to control the direction of travel of the vehicle 12. The steering arrangement 124 may include one or more steering members 125. The or each steering member 125 may be configured to engage a travel medium (e.g. land, water, or air) to cause the vehicle 12 to travel in a direction corresponding to the position of the or each steering member 125.

The steering members 125 may include one or more wheels which may be configured to engage a ground surface. The vehicle 12 may therefore be a wheeled vehicle 12. In some versions the steering members 125 may alternatively or additionally include other ground-engaging members such as one or more tracks. In other versions the steering members 125 may include one or more propellers (e.g. to control a direction of movement of a water-based vehicle such as a boat) or one or more wing-based steering members 125, such as one or more ailerons, elevators, rudders, spoilers, flaps, slats, and/or air brakes (e.g. to control a direction of movement of an air-based vehicle 12 such as an aeroplane).

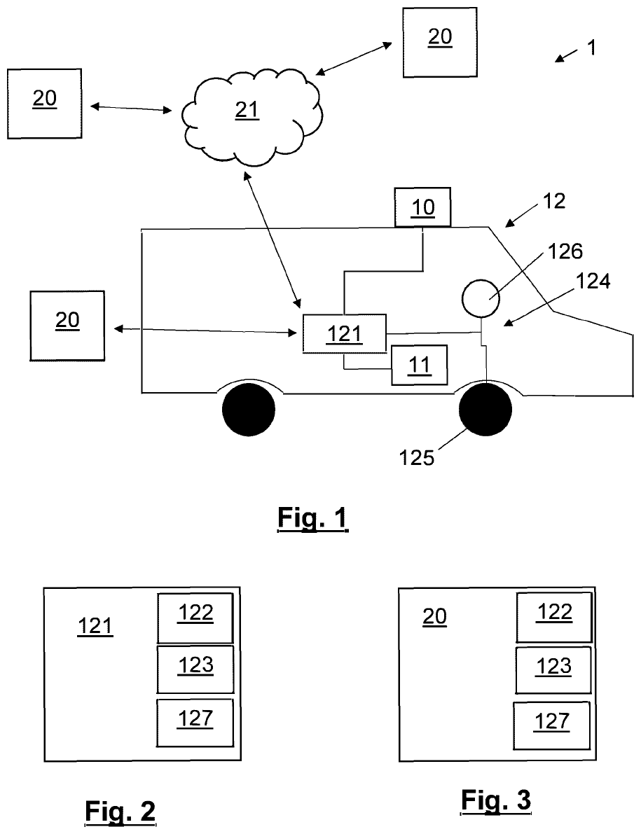

In some embodiments, the steering arrangement 124 may include a steering actuator 126 which may be configured to enable a user to control the or each steering member 125 (e.g. to control the position of the or each steering member 125). The user may therefore control the direction of travel of the vehicle 12 using the steering actuator 126. The steering actuator 126 may include for example a steering wheel 126 (e.g. in a car or other land vehicle 12), helm, boat wheel, or ship wheel (e.g. in a water-based vehicle 12), or yoke, tiller or control stick (e.g. for an air-based vehicle 12). FIG. 1 schematically illustrates a land vehicle 12 including a steering wheel 126 and ground-engaging wheels 125 (in this case four such wheels).

The steering actuator 126 may therefore be operably coupled to the or each steering member 125 to control the or each steering member 125. Likewise, the steering actuator 126 may be operably coupled to the or each steering member 125 to control the direction of travel of the vehicle 12.

In some embodiments, the steering actuator 126 may not be included. For example, the vehicle 12 may be an autonomous vehicle 12 (e.g. self-driving car) and therefore there may be no need for a user to control the vehicle 12.

The steering arrangement 124 may be operably coupled to the on-board computer system 121 and may be operably coupled to the vehicle control module 122 (which may be part of the on-board computer system 121 or may be remotely located, e.g. in the remote device 20). The vehicle control module 122 may therefore control the or each steering member 125 (e.g. in order to control the movement of the vehicle 12 and/or to control the direction of travel of the vehicle 12). In versions in which there is no steering actuator 126 provided, the vehicle 12 may therefore be controlled by the vehicle control module 122. In some versions the steering actuator 126 and the vehicle control module 122 may both be provided.

In some embodiments, the vehicle 12 may include a vision system 10 which may include one or more sensors. The one or more sensors may include sensors configured to sense electromagnetic waves (e.g. radio waves, visible light) and/or sensors configured to sense acoustic waves, for example. The vision system 10 may include a radar system, a lidar system, an ultrasound system, and/or a camera system, for example, and may include a combination of these systems. The vision system 10 may be operably coupled to the on-board computer system 121. The vision system 10 may determine and/or output (e.g. to the on-board computer system 121) vision data representative of the surroundings of the vehicle 12. The vision data may be used by the on-board computer system 121 (e.g. by the vehicle control module 122) to control the movement of the vehicle 12. For example, the on-board computer system 121 (e.g. the vehicle control module 122) may be configured to take the vision data into account when controlling the steering arrangement 124 (e.g. the steering member(s) 125 thereof). In some versions the vision data may be transmitted to the remote device 20 and the remote device 20 may send control instructions to the vehicle 12 (e.g. the vehicle control module 122 may be located in the remote device 20 as described).

In some embodiments, the vehicle 12 may include a location system 11. The location system 11 may be configured to determine the location of the vehicle 12. The location system 11 may be operably and/or communicatively coupled to the on-board computer system 121 and/or path controller 123 and/or vehicle control module 122. The location system 11 may be operably and/or communicatively coupled to the remote device 20 (e.g. via a wired or wireless communications link, whether directly or via the network 21).

As described, the vehicle control module 122 may control the movement of the vehicle 12. Some vehicle control systems and methods provide unsatisfactory vehicle control, which may be uncomfortable, unsettling, excessively wearing on a vehicle steering system, or even dangerous to the passengers of the vehicle and/or other road users. For example, some vehicle control systems and methods produce jerky and/or sudden changes in direction, especially at low speeds.

In some embodiments, the disclosure provides an improved vehicle control system 1 and method.

In some embodiments, the control system 1 may include a path controller 123. In some embodiments, the on-board computer system 121 may include the path controller 123. In some embodiments, the remote device 20 may include the path controller 123. In some embodiments, the path controller 123 may be split across a plurality of locations. A part of the path controller 123 may therefore be located remotely from the vehicle 12 (e.g. in the remote device 20) and a part of the path controller 123 may be located locally with respect to the vehicle 12 (e.g. in the on-board computer system 121). The path controller 123 may be located locally or remotely with respect to the vehicle 12. In some embodiments, the path controller 123 may be a cloud-based path controller 123. The path controller 123 may be operably coupled to the on-board computer system 121 and may be operably coupled to the vehicle control module 122. In some embodiments, the vehicle control module 122 may be part of the path controller 123. In other words, the path controller 123 may include the vehicle control module 122. The path controller 123 may therefore perform the functions of the vehicle control module 122.

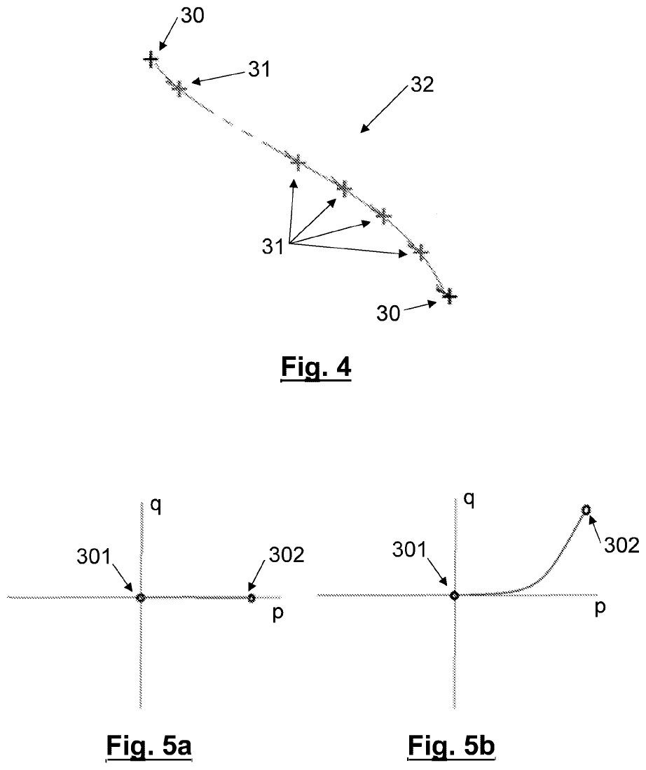

The path controller 123 may be configured to define a target path 32 for the vehicle 12 to follow (see e.g. FIG. 4). The vehicle control module 122 and/or path controller 123 may, therefore, control the movement of the vehicle 12 such that the vehicle 12 follows the target path 32. As will be appreciated, the vehicle 12 may not traverse the target path 32 exactly—for example the path driven or traced by the vehicle 12 may be slightly offset from the target path 32. However, the vehicle 12 may still be considered to be following the target path 32 in such circumstances.

In some embodiments, the path controller 123 may obtain waypoint data for a series of waypoints 30. The waypoints 30 may represent target locations for the vehicle 12 to pass through and may define a vehicle route. The vehicle route may represent a real-world route to be traversed by the vehicle 12. The waypoints 30 may be obtained from a map. The map may be a digital and/or virtual map, for example. The waypoint data may be stored in and/or with the map. The map may be a road map, for example. In some versions the map may be provided as a software application and the path controller 123 may interface with the map through an application programming interface (API), for example. The map may use a Cartesian coordinate system.

In some embodiments, the waypoint data may be stored separately from the map. The waypoint data may be stored on a non-transitory computer-readable storage medium. The waypoint data may be stored remotely from the path controller 123. The waypoint data may be stored at the remote device 20 (e.g. on the non-transitory computer-readable storage medium 127 thereof). The waypoint data may be stored in the cloud (e.g. on a cloud server). The waypoint data may be transmitted to the path controller 123 (e.g. from the cloud and/or from the remote device 20). The waypoint data may be stored on a non-transitory computer-readable storage medium operably coupled to the path controller 123.

The waypoint data may include position data. The position data may include a geographical position for each waypoint. The position data may include geographical coordinates, for example. The position data may include coordinates defined with respect to the map (i.e. map coordinates). The position data may include Cartesian coordinates corresponding to the map. The position data may therefore include x and y coordinates, which may correspond to the map. The position for each waypoint may correspond to a real-world location for each waypoint. The position of the or each waypoint may correspond to a point on a road in the real world, for example.

The waypoint data may include heading data. The heading data may include a navigational heading associated with each waypoint. The heading may represent a target direction of travel of the vehicle 12 at each waypoint. The heading may be determined based on the map, for example. The heading may be determined relative to a coordinate axis of the map. The heading may correspond to a heading of a road at a position defined by the position data, for example. In some versions, the heading may be determined by passing a series of waypoints having associated position data through software digital filters. The heading may be defined as an angle. The heading may be defined in radians or degrees. For example, the heading may be defined as an angle relative to an x axis or to a y axis of the map.

The waypoint data may include curvature data. The curvature data may represent heading data differentiated with respect to distance travelled (e.g. distance travelled along a road, which may be a road located at a position defined by the position data). The curvature data may therefore represent a rate of change of the heading with distance travelled. The curvature data may include a curvature associated with each waypoint. In other words, the curvature data may represent the tightness of a curve running through each waypoint, which may vary from no curve (e.g. driving in a straight line) to a tight curve (e.g. turning a sharp corner), for example. The curvature may be defined in terms of angle per distance. The curvature may be defined in radians per meter or degrees per meter, for example. The curvature may, therefore, correspond to a curvature of a road at a position defined by the position data.

The waypoint data may include inflection data. The inflection data may represent curvature data differentiated with respect to distance travelled (e.g. distance travelled along a road, which may be a road located at a position defined by the position data). The inflection data may therefore represent a rate of change of the curvature with distance travelled. The inflection data may include an inflection associated with each waypoint. In other words, the inflection data may represent how much the curvature changes with distance travelled, which may vary from no change (e.g. driving in a straight line or turning at a constant rate, such as when driving around a roundabout or a constant bend) to a rapid change (e.g. when making a sudden steering adjustment). The inflection may be defined in terms of angle per distance squared. The inflection may be defined in radians per meter squared, or degrees per meter squared, for example. The inflection may, therefore, correspond to an inflection of a road at a position defined by the position data.

The waypoint data may include speed limit data. The speed limit data may include a speed limit associated with each waypoint. The speed limit may correspond to a speed limit of a road at a position defined by the position data. The speed limit for a particular waypoint may therefore correspond to the speed limit of a road at the position of the waypoint.

For off-road implementations references to a “road” may be understood as referring to a corresponding characteristic, e.g. for nautical implementations the “road” may be a shipping lane, for aeronautical implementations the “road” may be a flight path, etc. For off-road ground vehicle implementations the “road” may be a track or similar, for example.

In some embodiments, the path controller 123 may be configured to interpolate between the waypoints 30 to define the target path 32. The path controller 123 may be configured to determine interpolation point data for a series of interpolation points 31 defining the target path 32. The path controller 123 may be configured to determine interpolation point data for the series of interpolation points 31 defining the target path 32 for the vehicle 12 by interpolating between the waypoints 30. The number of interpolation points 31 in the series of interpolation points 31 between adjacent waypoints 30 may be in the range of about 2-10,000, 100-5,000, 500-3,000, 500-2,000, 500-1,500, 600-1400, 700-1300, 800-1200, 900-1100, or 950-1050. The number of interpolation points 31 in the series of interpolation points 31 between adjacent waypoints 30 may be about 1,000. The number of interpolation points 31 in the target path 32 corresponding to the entire route to be driven by the vehicle 12 may therefore be proportional to the number of waypoints 30 in the route.

The path controller 123 may be configured to determine interpolation point data for the series of interpolation points 31. The interpolation points 31 may represent target locations for the vehicle 12 to pass through and may define the target path 32. The target path 32 may represent a real-world route to be traversed by the vehicle 12.

As described herein, in some embodiments, the path controller 123 may be located wholly or partly remotely from the vehicle 12 (e.g. may be at least partially cloud-based and/or at least partially located in the remote device 20). The determination of the interpolation point data may therefore be performed remotely from the vehicle 12 and the interpolation point data may be transmitted to the vehicle 12 (e.g. to the on-board computer system 121 and/or to the vehicle control module 122).

The interpolation point data may include interpolation position data. The interpolation position data may include a geographical position for each interpolation point. The interpolation position data may include geographical coordinates, for example. The interpolation position data may include coordinates defined with respect to the map. The position data may include Cartesian coordinates corresponding to the map. The position data may therefore include x and y coordinates, which may correspond to the map. The position data may correspond to a real-world location.

The interpolation point data may include interpolation heading data. The interpolation heading data may include a navigational heading associated with each interpolation point. The heading may represent a target direction of travel of the vehicle 12 at each interpolation point. The heading may be determined based on the map, for example. The heading may be determined relative to a coordinate axis of the map. The heading may correspond to a heading of a road at a position defined by the interpolation position data, for example. The heading may be defined as an angle. The heading may be defined in radians or degrees. For example, the heading may be defined as an angle relative to an x axis or to a y axis of the map.

The interpolation point data may include interpolation curvature data. The interpolation curvature data may represent interpolation heading data differentiated with respect to distance travelled (e.g. distance travelled along the target path 32). The interpolation curvature data may therefore represent a rate of change of the heading with distance travelled. The interpolation curvature data may include a curvature associated with each interpolation point. In other words, the interpolation curvature data may represent the tightness of a curve running through each interpolation point, which may vary from no curve (e.g. driving in a straight line) to a tight curve (e.g. turning a sharp corner), for example. The curvature may be defined in terms of angle per distance. The curvature may be defined in radians per meter or degrees per meter, for example.

The interpolation point data may include interpolation inflection data. The interpolation inflection data may represent interpolation curvature data differentiated with respect to distance travelled (e.g. distance travelled along the target path 32). The interpolation inflection data may therefore represent a rate of change of the curvature with distance travelled. The interpolation inflection data may include an inflection associated with each interpolation point. In other words, the interpolation inflection data may represent how much the curvature changes with distance travelled, which may vary from no change (e.g. driving in a straight line or turning at a constant rate, such as when driving around a roundabout or a constant bend) to a rapid change (e.g. when making a sudden steering adjustment). The inflection may be defined in terms of angle per distance squared. The inflection may be defined in radians per meter squared, or degrees per meter squared, for example.

FIG. 4 shows a schematic illustration of an embodiment of a target path 32 defined between two waypoints 30. The waypoints 30 are connected by interpolation points 31 as described herein. As described, each waypoint 30 and each interpolation point 31 may have an associated heading, curvature, and inflection.

In some embodiments, the path controller 123 may be configured to interpolate between the waypoints 30 using an integration technique. The path controller 123 may be configured to determine the interpolation point data using an integration technique. The path controller 123 may, therefore, be configured to interpolate between a first waypoint w and a second waypoint w+1 (which may be consecutive waypoints 30 in the series of waypoints 30). The path controller 123 may be configured to integrate between a first waypoint w and a second waypoint w+1 (which may be consecutive waypoints 30 in the series of waypoints 30). The path controller 123 may be configured to interpolate and/or integrate between successive pairs of waypoints w and w+1 in the series of waypoints 30 from the first waypoint 30 to the final waypoint 30 in the series of waypoints 30. The path controller 123 may therefore be configured to interpolate and/or integrate between all of the waypoints 30 in the series of waypoints 30 to define the target path 32. The path controller 123 may be configured to determine the closest two waypoints 30 to the vehicle 12 and to interpolate and/or integrate between these closest waypoints 30 to define the target path 32. The path controller 123 may therefore use the vehicle 12 location determined by the location system 11 to determine the closest waypoints 30 to the vehicle 12.

The path controller 123 may interpolate between the waypoints 30 and/or determine the interpolation point data using an equation of the form:

$$r ( {n}_{par} ) = {r}_{waypoint w} + {r}_{norm} {\int }_{waypoint w}^{waypoint w + 1} integrand {dn}_{par} \qquad ( i )$$

where r represents the position of the interpolation point as a complex number, nₚₐᵣ represents a parametric variable proportional to the distance travelled from the waypoint w towards the waypoint w+1, r_{waypoint} w represents the position of the waypoint w as a complex number, rₙₒᵣₘ represents a complex constant, waypoint w and waypoint w+1 represent the waypoints being interpolated between, and integrand represents the integrand.

The position of the interpolation point 31 may be expressed in the form (rₓ, r_{y}) and may be represented by r as a complex number of the form rₓ+ir_{y}.

The parametric variable nₚₐᵣ may represent a number proportional to the distance travelled from the waypoint w towards the waypoint w+1. For all pairs of waypoints w and w+1 the value of nₚₐᵣ may always be a first predetermined value at waypoint w and a second predetermined value at waypoint w+1. These predetermined values may be the same for every pair of waypoints 30.

The position r_{waypoint w} of the waypoint w as a complex number may be expressed in the form rₓ+ir_{y}.

More specifically, the path controller 123 may interpolate between the waypoints 30 and/or determine the interpolation point data using an equation of the form:

$$r ( {n}_{par} ) = {r}_{waypoint w} + {r}_{norm} {\int }_{waypoint w}^{waypoint w + 1} {e}^{i ( polynomial )} {dn}_{par} \qquad ( ii )$$

where polynomial represents a polynomial of the form:

$${n}_{coeff , p} {n}_{par}^{p} + {n}_{coeff , p - 1} {n}_{par}^{p - 1} + … + {n}_{coeff , 1} {n}_{par}$$

where n_{coeff,p} . . . n_{coeff,1} represent real constants and p represents the degree (i.e. order) of the polynomial. The quantities e and i have their normal mathematical meaning (i.e. e is Euler's number and i is the imaginary unit, \sqrt{−1}). In some versions polynomial may further include a constant term, although this may be redundant in some implementations as the role of the constant term may be fulfilled by rₙₒᵣₘ (and therefore the constant term may be zero, for example). In versions in which polynomial includes a constant term, rₙₒᵣₘ may represent a constant that is not complex.

The degree (i.e. order) of the polynomial may be at least 4, at least 5, at least 6, at least 7, at least 8, at least 9, or at least 10. The degree (i.e. order) of the polynomial may be in the range 4-10, 4-9, 4-8, 4-7, 5-8, or 5-7. The degree (i.e. order) of the polynomial may be a non-integer value (e.g. 6.06, 5.05, 4.04, etc). The degree (i.e. order) of the polynomial may be an even number such as an even number of at least 4 or at least 6 or a number such as 4, 6, 8, or 10.

The degree (i.e. order) of the polynomial may be 6. The path controller 123 may therefore interpolate between the waypoints 30 and/or determine the interpolation point data using an equation of the form:

$$r ( {n}_{par} ) = {r}_{waypoint w} + {r}_{norm} {\int }_{waypoint w}^{waypoint w + 1} {e}^{i ( {n}_{coeff , 6} {n}_{par}^{6} + {n}_{coeff , 5} {n}_{par}^{5} + … + {n}_{coeff , 1} {n}_{par} )} {dn}_{par} \qquad ( iii )$$

where the terms are defined as described herein.

In such embodiments, the polynomial in the exponent may define the heading of the interpolation point 31 offset by the angle of rₙₒᵣₘ. The exponent may present this as a complex number of unit magnitude, which may be used to determine the position (e.g. Cartesian position) of the interpolation point 31 (e.g. when integrated and multiplied by the complex constant rₙₒᵣₘ).

An example of a suitable computational method for implementing the numerical integration is the forward-Euler method.

Versions of the technology for use with air-based vehicles may include multiple polynomials, e.g. one for each of yaw, pitch, and roll.

In some embodiments, the interpolation techniques described herein may be used to determine the series of interpolation points 31 and the interpolation point data, including the heading, curvature, and inflection of each interpolation point 31. The determination of the inflection of each interpolation point 31 may enable the path controller 123 to define a target path that complies with safety, comfort and/or wear and tear limits. These limits may be set such that sudden or jerky changes in vehicle 12 direction are minimised or eliminated. The use of a sixth degree (i.e. order) polynomial (i.e. a sextic or hexic polynomial) as described herein may be particularly effective in this regard.

In some embodiments, the described control system 1 and method also provides a particularly efficient technique for performing interpolation calculations-such as those used to determine the interpolation point data.

The path controller 123 may be configured to interpolate between the waypoints 30 and/or to determine the interpolation point data using a matrix inversion technique.

The path controller 123 may be configured to interpolate between the waypoints 30 and/or to determine the interpolation point data using matrices of the general form:

$$[ \begin{matrix}\begin{matrix}{a}_{1} \\ ⋮\end{matrix} \\ {a}_{x}\end{matrix} ] = A [ \begin{matrix}\begin{matrix}{n}_{coeff , 1} \\ ⋮\end{matrix} \\ {n}_{coeff , p}\end{matrix} ] \qquad ( iv )$$

where each of the terms a₁ . . . aₓ include rₙₒᵣₘ, and where A represents a matrix that is a function of the limits of nₚₐᵣ. The path controller 123 may be further configured to calculate the inverse matrix A⁻, and this calculation may be performed when the limits of nₚₐᵣ are set. The matrix A⁻¹ may be used in subsequent calculation steps as described herein. In some versions, the limits of nₚₐᵣ may be in the range of about −0.5 to −1.5, about −0.6 to −1.4, about −0.7 to −1.3, about −0.8 to −1.2, about −0.9 to −1.1, or about −1 at waypoint w and may be in the range of about 0.5 to 1.5, about 0.6 to 1.4, about 0.7 to 1.3, about 0.8 to 1.2, about 0.9 to 1.1, or about 1 at waypoint w+1.

For example, the limits of nₚₐᵣ may be about −1 at waypoint w and about 1 at waypoint w+1. In some versions the limits of nₚₐᵣ may be about −0.9 at waypoint w and about 0.9 at waypoint w+1.

In some embodiments, the path controller 123 may be configured to interpolate between the waypoints 30 and/or to determine the interpolation point data using matrices of the general form:

$$[ \begin{matrix}\begin{matrix}\begin{matrix}\begin{matrix}\begin{matrix}( heading at w ) - ( angle of {r}_{norm} ) \\ ( curvature at w ) \times ( modulus of {r}_{norm} )\end{matrix} \\ ( inflection at w ) \times {( modulus of {r}_{norm} )}^{2}\end{matrix} \\ ( heading at w + 1 ) - ( angle of {r}_{norm} )\end{matrix} \\ ( curvature at w + 1 ) \times ( modulus of {r}_{norm} )\end{matrix} \\ ( inflection at w + 1 ) \times {( modulus of {r}_{norm} )}^{2}\end{matrix} ] = A [ \begin{matrix}\begin{matrix}\begin{matrix}\begin{matrix}\begin{matrix}{n}_{coeff , 1} \\ {n}_{coeff , 2}\end{matrix} \\ {n}_{coeff , 3}\end{matrix} \\ {n}_{coeff , 4}\end{matrix} \\ {n}_{coeff , 5}\end{matrix} \\ {n}_{coeff , 6}\end{matrix} ] \qquad ( v )$$

The matrices shown in (v) may in particular be used with equation (iii).

The matrices shown in (v) are particularly suitable for use with the limits of nₚₐᵣ set to −1 at waypoint w and 1 at waypoint w+1. The matrices shown in (v) are also compatible with the limits of nₚₐᵣ set to −0.9 at waypoint w and 0.9 at waypoint w+1, for example. Other choices of limits for nₚₐᵣ are possible with corresponding adjustments to the matrices shown.

The matrix A may have the general form:

$$A = [ \begin{matrix}{n}_{par , w} & {n}_{par , w}^{2} & {n}_{par , w}^{3} & {n}_{par , w}^{4} & {n}_{par , w}^{5} & {n}_{par , w}^{6} \\ 1 & 2 {n}_{par , w} & 3 {n}_{par , w}^{2} & 4 {n}_{par , w}^{3} & 5 {n}_{par , w}^{4} & 6 {n}_{par , w}^{5} \\ 0 & 2 & 6 {n}_{par , w} & 12 {n}_{par , w}^{2} & 20 {n}_{par , w}^{3} & 30 {n}_{par , w}^{4} \\ {n}_{par , w + 1} & {n}_{par , w + 1}^{2} & {n}_{par , w + 1}^{3} & {n}_{par , w + 1}^{4} & {n}_{par , w + 1}^{5} & {n}_{par , w + 1}^{6} \\ 1 & 2 {n}_{par , w + 1} & 3 {n}_{par , w + 1}^{2} & 4 {n}_{par , w + 1}^{3} & 5 {n}_{par , w + 1}^{4} & 6 {n}_{par , w + 1}^{5} \\ 0 & 2 & 6 {n}_{par , w + 1} & 12 {n}_{par , w + 1}^{2} & 20 {n}_{par , w + 1}^{3} & 30 {n}_{par , w + 1}^{4}\end{matrix} ]$$

The term nₚₐᵣ,w may represent the limit of nₚₐᵣ at waypoint w and the term nₚₐᵣ,w+₁ may represent the limit of nₚₐᵣ at waypoint w+1. The inverse matrix A⁻¹ may be determined from the matrix A by known methods. The matrix A is, therefore, a function of the limits of nₚₐᵣ. Where the limits of nₚₐᵣ are constant, the matrix A is therefore a constant. Accordingly, the value of A may be predetermined and may be provided to the path controller 123. The value of A may be stored with the waypoint data and may be a part of the waypoint data, for example. Likewise, the value of A⁻¹ may also be a constant which may be predetermined and may be provided to the path controller 123 and may be stored with the waypoint data, optionally as part of the waypoint data. In some versions the path controller 123 may determine the value of A and A⁻¹ using the limits of nₚₐᵣ.

The path controller 123 may be configured to interpolate between the waypoints 30 and/or to determine the interpolation point data by assigning a value to rₙₒᵣₘ (in an equation of the form shown in equations (i)-(iii) herein). The value assigned to rₙₒᵣₘ may be the value that would join the two waypoints w and w+1 if the integral shown in equations (i)-(iii) returned a value of 1. The value assigned to rₙₒᵣₘ may be random, or may be a predetermined value. In some versions the same initial value of rₙₒᵣₘ may be used for each pair of waypoints w and w+1.

The path controller 123 may be further configured to determine the coefficients n_{coeff,1} . . . n_{coeff, p} shown in equations (ii) and (iii) (x being 6 in equation (iii)) for the assigned value of rₙₒᵣₘ. The coefficients may be determined using the inverse matrix A⁻¹. The coefficients may be determined using matrices of the general form:

$$[ \begin{matrix}\begin{matrix}{n}_{coeff , 1} \\ ⋮\end{matrix} \\ {n}_{coeff , p}\end{matrix} ] = {A}^{- 1} [ \begin{matrix}\begin{matrix}{a}_{1} \\ ⋮\end{matrix} \\ {a}_{x}\end{matrix} ] \qquad ( v )$$

The coefficients may be determined using matrices of the general form:

$$[ \begin{matrix}\begin{matrix}\begin{matrix}\begin{matrix}\begin{matrix}{n}_{coeff , 1} \\ {n}_{coeff , 2}\end{matrix} \\ {n}_{coeff , 3}\end{matrix} \\ {n}_{coeff , 4}\end{matrix} \\ {n}_{coeff , 5}\end{matrix} \\ {n}_{coeff , 6}\end{matrix} ] = {A}^{- 1} [ \begin{matrix}\begin{matrix}\begin{matrix}\begin{matrix}\begin{matrix}( heading at w ) - ( angle of {r}_{norm} ) \\ ( curvature at w ) \times ( modulus of {r}_{norm} )\end{matrix} \\ ( inflection at w ) \times {( modulus of {r}_{norm} )}^{2}\end{matrix} \\ ( heading at w + 1 ) - ( angle of {r}_{norm} )\end{matrix} \\ ( curvature at w + 1 ) \times ( modulus of {r}_{norm} )\end{matrix} \\ ( inflection at w + 1 ) \times {( modulus of {r}_{norm} )}^{2}\end{matrix} ] \qquad ( vi )$$

In some embodiments, the path controller 123 may be configured to determine the heading, curvature, and inflection of each interpolation point 31 using the determined coefficients. The path controller 123 may be configured to determine the position of each interpolation point 31 using an equation of the form shown in equation (ii) or (iii) by substituting the determined coefficient values into the equation. The path controller 123 may be configured to use numerical integration to solve equations of the form shown in equations (i)-(iii).

In some embodiments, the position of the final interpolation point 31 in the series of interpolation points 31 should optimally coincide with the position of the waypoint w+1; however, it is likely that there will be a position error between the two. Therefore, the path controller 123 may be further configured to determine the complex error in position between the final interpolation point 31 and the waypoint w+1. The path controller 123 may be configured to assign a new value to rₙₒᵣₘ to reduce the position error. The path controller 123 may be configured to reduce the position error by subtracting a proportion of the error from rₙₒᵣₘ.

The path controller 123 may be configured to repeat the process with the new value of rₙₒᵣₘ. As the process repeats, the error will be reduced. The path controller 123 may be configured to continue the repetition until at least one termination criterion is met.

In some embodiments, the termination criterion may include a predetermined number of repetitions. The predetermined number of repetitions may be in the range of about 2-100, 3-50, 5-30, 10-25, 10-20, 11-19, 12-18, 13-17, or 14-16. The predetermined number of repetitions may be about 15. The termination criterion may include a predetermined threshold position error, wherein the process may be terminated if the position error is below and/or within the threshold. The termination criterion may include a predetermined length of time for which the process has been running.

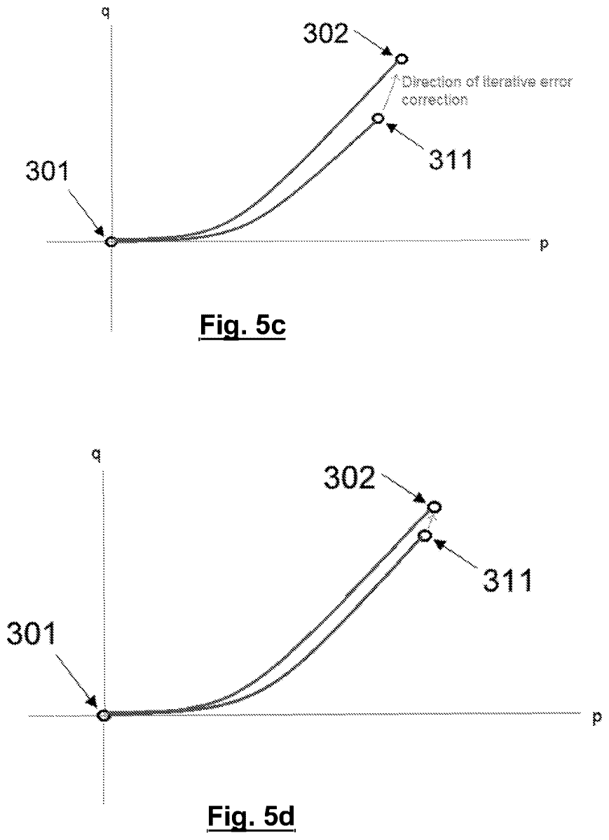

The path controller 123 may be configured to translate and/or rotate each pair of waypoints w and w+1 on to a reference plane (e.g. defined as a plane p-q). In such versions, waypoint w may be located at the origin of the reference plane. The heading of waypoint w may be represented as zero in the reference plane, e.g. such that the heading is aligned with the p axis of the p-q plane (which may be analogous to the x axis in an x-y frame of reference, for example). FIG. 5a illustrates an example of a waypoint w 301 and a waypoint w+1 302 connected by a straight path. In this case, waypoint w+1 302 is located on the p axis as illustrated. In this case, using the error correction method described above, rₙₒᵣₘ would be a real number (i.e. without an angle). The location of the final interpolation point would therefore coincide with waypoint w+1 302 and so the iterative error correction would produce no change.

However, in some instances the path between waypoint w 301 and waypoint w+1 302 may be curved. An example of such a case is illustrated in FIG. 5b. In such cases, as described, the waypoint w may be located at the origin of the reference plane. The heading of waypoint w may be represented as zero in the reference plane, e.g. such that the heading is aligned with the p axis of the p-q plane (which may be analogous to the x axis in an x-y frame of reference, for example). However, in such cases, due to the curvature of the path, the location of the waypoint w+1 302 may not coincide with the p axis.

Using the iterative error correction method described above, a value may accordingly be assigned to rₙₒᵣₘ that would correspond to the position of waypoint w+1 on the p-q plane as the equivalent complex number. In other words, the initial value of rₙₒᵣₘ may be the coordinate (p_{w+1}, q_{w+1}) of waypoint w+1 on the p-q plane—ie. p_{w-1}+iq_{w+1}. As illustrated in FIG. 5c, there may be an error between the location of the final interpolation point 311 and waypoint w+1 302. As described above, the iterative error correction process may then assign a new value to rₙₒᵣₘ to reduce this error, and may recalculate the position of the final interpolation point (e.g. using the described inverse matrix method). Over the course of the iterations, the error will reduce, as illustrated in FIG. 5d.

In some embodiments, the path controller 123 may be configured to perform the interpolation calculation on the plane (e.g. p-q plane) to determine the interpolation points 31 and/or interpolation point data. The path controller 123 may be further configured to perform an inverse translation and/or rotation on the determined interpolation points 31 and/or interpolation point data to convert these back to the original frame of reference, which may be the frame of reference of the map (e.g. x-y and/or Cartesian frame of reference). The path controller 123 may be configured to perform an inverse translation and/or rotation on the curve position formula (e.g. equation (i), (ii) or (iii)). This may prevent or inhibit angular wraparound.

The path controller 123 may therefore define the target path 32 for the vehicle 12 using the determined interpolation points 31 and/or interpolation point data.

In some embodiments, the vehicle control module 122 may be part of the path controller 123 and therefore the path controller 123 may be configured to control the movement of the vehicle 12. The path controller 123 may therefore be configured to control the vehicle 12 such that the vehicle 12 follows the target path. Similarly, in some versions, the path controller 123 may be part of the vehicle control module 122.

The path controller 123 may be configured to determine the closest point on the target path 32 to the vehicle 12. The closest point may be an interpolation point 31 or a waypoint 30. In some versions the path controller 123 may be configured to determine the closest interpolation point 31 to the vehicle 12. The error between the vehicle 12 position and the position of the closest point (e.g. closest interpolation point 31) may be determined by the path controller 123. This error may be a lateral position error. The path controller 123 may use the vehicle 12 location provided by the location system 11 to determine the closest point on the target path 32.

In some embodiments, the path controller 123 may treat the target path 32 and the lateral error using a feed-forward (e.g. derivative feed-forward) and/or closed-loop controller such as a proportional closed-loop controller. The feed-forward term may replicate the heading of the closest point (e.g. closest interpolation point 31) on the target path 32 and may also determine its curvature and inflection with respect to vehicle 12 distance travelled.

The closed-loop calculation may close the lateral error between the vehicle 12 and the target path 32 using a pure pursuit technique. A pure pursuit target may therefore be provided and the path controller 123 and/or vehicle control module 122 may control the vehicle 12 such that the vehicle 12 moves towards the pure pursuit target. The position of the pure pursuit target may correspond to the position of the closest point on the target path 32 (e.g. closest interpolation point 31) plus a predetermined or variable pure pursuit look-ahead distance taken in the direction of the heading of the closest point. The path controller 123 and/or vehicle control module 122 may therefore control the vehicle 12 to travel on a heading in the direction of the pure pursuit target. The heading of the pure pursuit target with respect to the vehicle 12 may be referred to as the desired heading. The pure pursuit look-ahead distance may vary (e.g. proportionally) with vehicle 12 speed and/or velocity.

In some embodiments, the path controller 123 may determine a desired curvature to move the vehicle 12 onto the desired heading. The path controller 123 may determine a required inflection to move the vehicle 12 onto the desired curvature.

The path controller 123 may integrate the required inflection to determine a required curvature for the steering arrangement 124. The path controller 123 and/or vehicle control module 122 may control the steering arrangement 124 such that the steering arrangement 124 moves to the required curvature, and may do so at a rate corresponding to the required inflection.

The path controller 123 may be configured to minimise the required inflection. The path controller 123 may be configured not to exceed a threshold maximum required inflection. The path controller 123 may, therefore, be configured to drive the vehicle 12 smoothly and safely.

In some embodiments, the disclosure provides many benefits over prior art control systems and methods. For example, the control system 1 and method described herein may be used to drive a vehicle smoothly and safely, while minimising wear on the vehicle. The use of waypoint data including position, curvature and/or inflection data may facilitate the construction of a smoother target path for a vehicle. Furthermore, the determination of interpolation point data including position, curvature and/or inflection data may also facilitate the construction of a smoother target path for the vehicle. The use of the equations shown herein may also facilitate smooth driving of the vehicle. In some embodiments, the use of a sextic polynomial may be particularly effective. Furthermore, the described iterative calculation involving the matrix inverse method runs quickly and efficiently, which may facilitate safe real-time vehicle control using the described system and method.

In some embodiments, the control system 1 and method described herein may allow the storage and/or generation of a smooth vehicle path with waypoints spaced much further apart, in some cases, than would be possible with a solely position-based (e.g. x,y) set of waypoints. Accordingly, the waypoint data that may be used to construct the vehicle path can effectively be compressed using the technology disclosed herein. For example, a series of position-based waypoints spaced 1 meter apart could be compressed using the technology disclosed herein to a set of waypoints spaced as far as 50 meters apart, giving a compression rate of e.g. 20:1.

In some embodiments, the disclosure may also be used in mapping tools, such as for drawing out and editing maps that use the type of path definition described herein, for example. Accordingly, the disclosed technology may include a method of generating a map, the method comprising: generating, using a processor, waypoint data for a series of waypoints; determining, using a processor, interpolation point data for a series of interpolation points defining a target path by interpolating between the waypoints; and storing the target path in a computer-readable non-transitory storage medium, wherein the waypoint data includes position data and at least one of heading data, curvature data, and/or inflection data, wherein curvature data represents heading data differentiated with respect to distance travelled and inflection data represents curvature data differentiated with respect to distance travelled. The map may be a map for an autonomous vehicle and the target path may be a target path for the vehicle. In some embodiments, the method may use the techniques described herein to determine the interpolation point data, such as by using any of the equations (i)-(vi) described herein or more generally by using the interpolation and matrix inversion techniques described herein. The technology may, therefore, be used to create a new map or to edit an existing map, for example. The processor or processors used to generate the map may be a processor or processors of the path controller 123, for example.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

Exemplary, non-limiting embodiments are set out in the following clauses, which stand alone or may be combined, in any combination, with one or more features disclosed in the text and/or drawings of the specification.
1. A method of controlling a vehicle, the method including:
   providing waypoint data for a series of waypoints to a path controller;
   using the path controller to determine interpolation point data for a series of interpolation points defining a target path for the vehicle by interpolating between the waypoints; and
   controlling the vehicle such that the vehicle follows the target path,
   wherein the waypoint data includes position data and at least one of heading data, curvature data, and/or inflection data, or wherein the waypoint data includes position data and the method includes using the path controller to determine at least one of heading data, curvature data, and/or inflection data using the waypoint data,
   wherein curvature data represents heading data differentiated with respect to distance travelled and inflection data represents curvature data differentiated with respect to distance travelled.
2. A method according to clause 1, wherein the waypoint data includes position data, heading data, curvature data, and inflection data.
3. A method according to any preceding clause, wherein the interpolation point data includes interpolation position data and at least one of interpolation heading data, interpolation curvature data, and/or interpolation inflection data.
4. A method according to clause 3, wherein the interpolation point data includes interpolation position data, interpolation heading data, interpolation curvature data, and interpolation inflection data.
5. A method according to any preceding clause, wherein the path controller determines the interpolation point data using an equation of the form:

$$r ( {n}_{par} ) = {r}_{waypoint w} + {r}_{norm} {\int }_{waypoint w}^{waypoint w + 1} integrand {dn}_{par}$$

where r represents the position of the interpolation point, nₚₐᵣ represents a parametric variable proportional to the distance travelled from the waypoint w towards the waypoint w+1, r_{waypoint} w represents the position of the waypoint w, rₙₒᵣₘ represents a constant, waypoint w and waypoint w+1 represent the waypoints being interpolated between; and integrand represents the integrand.
6. A method according to clause 5, wherein r represents the position of the interpolation point as a complex number, r_{waypoint w} represents the position of the waypoint w as a complex number, and rₙₒᵣₘ represents a complex constant.
7. A method according to clause 5 or 6, wherein the path controller determines the interpolation point data using an equation of the form:

$$r ( {n}_{par} ) = {r}_{waypoint w} + {r}_{norm} {\int }_{waypoint w}^{waypoint w + 1} {e}^{i ( polynomial )} {dn}_{par}$$

where polynomial represents a polynomial of the form:

$${n}_{coeff , p} {n}_{par}^{p} + {n}_{coeff , p - 1} {n}_{par}^{p - 1} + … + {n}_{coeff , 1} {n}_{par}$$

where n_{coeff,p} . . . n_{coeff, 1} represent constants and p represents the degree of the polynomial.
8. A method according to clause 7, wherein n_{coeff,p} . . . n_{coeff, 1} represent real constants.
9. A method according to clause 7 or 8, wherein the degree of the polynomial is 6.
10. A method according to any preceding clause, wherein the path controller determines the interpolation point data using a matrix inversion technique.
11. A method according to clause 10 when dependent on any of clauses 7-9, wherein the path controller determines the interpolation point data using matrices of the general form:

$$[ \begin{matrix}\begin{matrix}{a}_{1} \\ ⋮\end{matrix} \\ {a}_{x}\end{matrix} ] = A [ \begin{matrix}\begin{matrix}{n}_{coeff , 1} \\ ⋮\end{matrix} \\ {n}_{coeff , p}\end{matrix} ]$$

where each of the terms a₁ . . . aₓ include rₙₒᵣₘ, and where A represents a matrix that is a function of the limits of nₚₐᵣ.
12. A method according to clause 11, wherein the path controller determines the interpolation point data by:
   assigning a value to rₙₒᵣₘ;
   determining the coefficients n_{coeff,1} . . . n_{coeff,p} using the inverse matrix A⁻¹ using matrices of the general form:

$$[ \begin{matrix}\begin{matrix}{n}_{coeff , 1} \\ ⋮\end{matrix} \\ {n}_{coeff , p}\end{matrix} ] = {A}^{- 1} [ \begin{matrix}\begin{matrix}{a}_{1} \\ ⋮\end{matrix} \\ {a}_{x}\end{matrix} ]$$

determining the heading, curvature, and inflection of each interpolation point using the determined coefficients;
   determining the position of each interpolation point by substituting the determined coefficients into the polynomial;
   determining the error in position between the final interpolation point and waypoint w+1; and
   assigning a new value to rₙₒᵣₘ to reduce the error and repeating the process until at least one termination criterion is met.
13. A method according to clause 12, wherein the error in position between the final interpolation point and waypoint w+1 is determined as a complex error.
14. A method according to clause 11, wherein the path controller determines the interpolation point data using matrices of the general form:

$$[ \begin{matrix}\begin{matrix}\begin{matrix}\begin{matrix}\begin{matrix}( heading at w ) - ( angle of {r}_{norm} ) \\ ( curvature at w ) \times ( modulus of {r}_{norm} )\end{matrix} \\ ( inflection at w ) \times {( modulus of {r}_{norm} )}^{2}\end{matrix} \\ ( heading at w + 1 ) - ( angle of {r}_{norm} )\end{matrix} \\ ( curvature at w + 1 ) \times ( modulus of {r}_{norm} )\end{matrix} \\ ( inflection at w + 1 ) \times {( modulus of {r}_{norm} )}^{2}\end{matrix} ] = A [ \begin{matrix}\begin{matrix}\begin{matrix}\begin{matrix}\begin{matrix}{n}_{coeff , 1} \\ {n}_{coeff , 2}\end{matrix} \\ {n}_{coeff , 3}\end{matrix} \\ {n}_{coeff , 4}\end{matrix} \\ {n}_{coeff , 5}\end{matrix} \\ {n}_{coeff , 6}\end{matrix} ]$$

15. A method according to clause 14, wherein the path controller determines the interpolation point data by:
   assigning a value to rₙₒᵣₘ;
   determining the coefficients n_{coeff,1} . . . n_{coeff,p} using the inverse matrix A⁻¹ using matrices of the general form:

$$[ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ] = {A}^{- 1} [ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ]$$

determining the heading, curvature, and inflection of each interpolation point using the determined coefficients;
   determining the position of each interpolation point by substituting the determined coefficients into the polynomial;
   determining the error in position between the final interpolation point and waypoint w+1; and
   assigning a new value to rₙₒᵣₘ to reduce the error and repeating the process until a termination criterion is met.
16. A method according to clause 15, wherein the error in position between the final interpolation point and waypoint w+1 is determined as a complex error.
17. A method according to clause 12, 13, 15 or 16, wherein the termination criterion includes a predetermined number of repetitions.
18. A system for controlling a vehicle, the system including:
   a non-transitory computer-readable storage medium; and
   a path controller operably coupled to the storage medium,
   wherein the path controller is configured to obtain waypoint data for a series of waypoints from the storage medium and to determine interpolation point data for a series of interpolation points defining a target path for the vehicle by interpolating between the waypoints,
   wherein the path controller is configured to control the vehicle such that the vehicle follows the target path,
   wherein the waypoint data includes position data and at least one of heading data, curvature data, and/or inflection data, or wherein the waypoint data includes position data and the method includes using the path controller to determine at least one of heading data, curvature data, and/or inflection data using the waypoint data,
   wherein the curvature data represents heading data differentiated with respect to distance travelled and the inflection data represents curvature data differentiated with respect to distance travelled.
19. A system according to clause 18, wherein the waypoint data includes position data, heading data, curvature data, and inflection data.
20. A system according to any of clauses 18-19, wherein the interpolation point data includes interpolation position data and at least one of interpolation heading data, interpolation curvature data, and/or interpolation inflection data.
21. A system according to clause 20, wherein the interpolation point data includes interpolation position data, interpolation heading data, interpolation curvature data, and interpolation inflection data.
22. A system according to any of clauses 18-21, wherein the path controller is configured to determine the interpolation point data using an equation of the form:

$$r ( {n}_{par} ) = {r}_{waypoint w} + {r}_{norm} {\int }_{waypoint w}^{waypoint w + 1} integrand {dn}_{par}$$

where r represents the position of the interpolation point, nₚₐᵣ represents a parametric variable proportional to the distance travelled from the waypoint w towards the waypoint w+1, r_{waypoint w} represents the position of the waypoint w, rₙₒᵣₘ represents a constant, waypoint w and waypoint w+1 represent the waypoints being interpolated between; and integrand represents the integrand.
23. A system according to clause 22, wherein r represents the position of the interpolation point as a complex number, r_{waypoint w} represents the position of the waypoint w as a complex number, and rₙₒᵣₘ represents a complex constant.
24. A system according to clause 22 or 23, wherein the path controller is configured to determine the interpolation point data using an equation of the form:

$$r ( {n}_{par} ) = {r}_{waypoint w} + {r}_{norm} {\int }_{waypoint w}^{waypoint w + 1} {e}^{i ( polynomial )} {dn}_{par}$$

where polynomial represents a polynomial of the form:

$${n}_{coeff , p} {n}_{par}^{p} + {n}_{coeff , p - 1} {n}_{par}^{p - 1} + ⋯ + {n}_{coeff , 1} {n}_{par}$$

where n_{coeff, p} . . . n_{coeff, 1} represent constants an p represents the degree of the polynomial.
25. A system according to clause 24, wherein n_{coeff, p} . . . n_{coeff,1} represent real constants.
26. A system according to clause 24 or 25, wherein the degree of the polynomial is 6.
27. A system according to any of clauses 18-26, wherein the path controller is configured to determine the interpolation point data using a matrix inversion technique.
28. A system according to clause 27 when dependent on any of clauses 24-26, wherein the path controller is configured to determine the interpolation point data using matrices of the general form:

$$[ \begin{matrix}{a}_{1} \\ ⋮ \\ {a}_{x}\end{matrix} ] = A [ \begin{matrix}{n}_{coeff , 1} \\ ⋮ \\ {n}_{coeff , p}\end{matrix} ]$$

where each of the terms a₁ . . . aₓ include rₙₒᵣₘ, and
where A represents a matrix that is a function of the limits of nₚₐᵣ.
29. A system according to clause 28, wherein the path controller is configured to determine the interpolation point data by:
   assigning a value to rₙₒᵣₘ;
   determining the coefficients n_{coeff,1} . . . n_{coeff,p} using the inverse matrix A⁻¹ using matrices of the general form:

$$[ \begin{matrix}{n}_{coeff , 1} \\ ⋮ \\ {n}_{coeff , p}\end{matrix} ] = {A}^{- 1} [ \begin{matrix}{a}_{1} \\ ⋮ \\ {a}_{x}\end{matrix} ]$$

determining the heading, curvature, and inflection of each interpolation point using the determined coefficients;
   determining the position of each interpolation point by substituting the determined coefficients into the polynomial;
   determining the error in position between the final interpolation point and waypoint w+1; and
   assigning a new value to rₙₒᵣₘ to reduce the error and repeating the process until at least one termination criterion is met.
30. A system according to clause 29, wherein the error in position between the final interpolation point and waypoint w+1 is determined as a complex error.
31. A system according to clause 28, wherein the path controller is configured to determine the interpolation point data using matrices of the general form:

$$[ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ] = A [ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ]$$

32. A system according to clause 31, wherein the path controller is configured to determine the interpolation point data by:
   assigning a value to rₙₒᵣₘ;
   determining the coefficients n_{coeff,1} . . . n_{coeff,p} using the inverse matrix A⁻¹ using matrices of the general form:

$$[ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ] = {A}^{- 1} [ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ]$$

determining the heading, curvature, and inflection of each interpolation point using the determined coefficients;
   determining the position of each interpolation point by substituting the determined coefficients into the polynomial;
   determining the error in position between the final interpolation point and waypoint w+1; and
   assigning a new value to rₙₒᵣₘ to reduce the error and repeating the process until a termination criterion is met.
33. A system according to clause 32, wherein the error in position between the final interpolation point and waypoint w+1 is determined as a complex error.
34. A system according to clause 29, 30, 32 or 33, wherein the termination criterion includes a predetermined number of repetitions.
35. A computer program product or computer-readable storage medium comprising instructions which, when executed by a computer, cause the computer to carry out the method of any of clauses 1-17.
36. A method of generating a map, the method comprising:
   generating, using a processor, waypoint data for a series of waypoints;
   determining, using a processor, interpolation point data for a series of interpolation points defining a target path by interpolating between the waypoints; and
   storing the target path in a computer-readable non-transitory storage medium,
   wherein the waypoint data includes position data and at least one of heading data, curvature data, and/or inflection data,
   wherein curvature data represents heading data differentiated with respect to distance travelled and inflection data represents curvature data differentiated with respect to distance travelled.
37. A method according to clause 36, wherein the map is a map for an autonomous vehicle and the target path is a target path for the vehicle.

1. A method of controlling a vehicle, the method comprising:
providing waypoint data for a series of waypoints to a path controller;
using the path controller to determine interpolation point data for a series of interpolation points defining a target path for the vehicle by interpolating between the waypoints; and
controlling the vehicle such that the vehicle follows the target path, wherein:
(a) the waypoint data includes position data and at least one of heading data, curvature data, and/or inflection data,
or
(b) the waypoint data includes the position data and the method includes using the path controller to determine, using the waypoint data, the at least one of the heading data, the curvature data, and/or the inflection data,
and
wherein the curvature data represents the heading data differentiated with respect to distance travelled and the inflection data represents the curvature data differentiated with respect to the distance travelled.

2. The method according to claim 1, wherein the waypoint data includes the heading data, the curvature data, and the inflection data.

3. The method according to claim 1, wherein the interpolation point data includes interpolation position data and at least one of interpolation heading data, interpolation curvature data, and/or interpolation inflection data.

4. The method according to claim 31, wherein the interpolation point data includes interpolation position data, interpolation heading data, interpolation curvature data, and interpolation inflection data.

5. The method according to claim 1, wherein the path controller determines the interpolation point data using an equation of the form:
$$r ( {n}_{par} ) = {r}_{waypoint w} + {r}_{norm} {\int }_{waypoint w}^{waypoint w + 1} integrand {dn}_{par} .$$
wherein:
r represents the position of the interpolation point,
nₚₐᵣ represents a parametric variable proportional to the distance travelled from the waypoint w towards the waypoint w+1,
r_{waypoint w} represents the position of the waypoint w,
rₙₒᵣₘ represents a constant,
waypoint w and waypoint w+1 represent the waypoints being interpolated between, and
integrand represents the integrand.

6. The method according to claim 5, wherein the path controller determines the interpolation point data using an equation of the form:
$$r ( {n}_{par} ) = {r}_{waypoint w} + {r}_{norm} {\int }_{waypoint w}^{waypoint w + 1} {e}^{i ( polynomial )} {dn}_{par} .$$
wherein:
polynomial represents a polynomial of the form:
$${n}_{coeff , p} {n}_{par}^{p} + {n}_{coeff , p - 1} {n}_{par}^{p - 1} + ⋯ + {n}_{coeff , 1} {n}_{par} .$$
n_{coeff, p} . . . n_{coeff,1} represent constants and p represents the degree of the polynomial.

7. The method according to claim 6, wherein the degree of the polynomial is 6.

8. The method according to claim 6, wherein the path controller determines the interpolation point data using a matrix inversion technique.

9. The method according to claim 8, wherein the path controller determines the interpolation point data using matrices of the general form:
$$[ \begin{matrix}{a}_{1} \\ ⋮ \\ {a}_{x}\end{matrix} ] = A [ \begin{matrix}{n}_{coeff , 1} \\ ⋮ \\ {n}_{coeff , p}\end{matrix} ] .$$
wherein:
each of the terms a₁ . . . aₓ include rₙₒᵣₘ, and
A represents a matrix that is a function of the limits of nₚₐᵣ.

10. The method according to claim 9, wherein the path controller determines the interpolation point data by:
(a) assigning a value to rₙₒᵣm;
(b) determining the coefficients n_{coeff, 1} . . . n_{coeff, p} using the inverse matrix A⁻¹ using matrices of the general form:
$$[ \begin{matrix}{n}_{coeff , 1} \\ ⋮ \\ {n}_{coeff , p}\end{matrix} ] = {A}^{- 1} [ \begin{matrix}{a}_{1} \\ ⋮ \\ {a}_{x}\end{matrix} ] ;$$
(c) determining a heading, a curvature, and an inflection of each interpolation point using the determined coefficients;
(d) determining a position of each interpolation point by substituting the determined coefficients into the polynomial;
(e) determining the error in position between the final interpolation point and waypoint w+1;
(f) assigning a new value to rₙₒᵣₘ to reduce the error; and
(q) repeating the process associated with (b)-(f) until at least one termination criterion is met.

11. The method according to claim 9, wherein the path controller determines the interpolation point data using matrices of the general form:
$$[ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ] = A [ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ] .$$

12. The method according to claim 11, wherein the path controller determines the interpolation point data by:
(a) assigning a value to rₙₒᵣₘ;
(b) determining the coefficients n_{coeff, 1} . . . n_{coeff,p} using the inverse matrix A⁻¹ using matrices of the general form:
$$[ \begin{matrix}{n}_{coeff , 1} \\ {n}_{coeff , 2} \\ {n}_{coeff , 3} \\ {n}_{coeff , 4} \\ {n}_{coeff , 5} \\ {n}_{coeff , 6}\end{matrix} ] = {A}^{- 1} [ \begin{matrix}( heading at w ) - ( angle of {r}_{norm} ) \\ ( curvature at w ) \times ( modulus of {r}_{norm} ) \\ ( inflection at w ) \times {( modulus of {r}_{norm} )}^{2} \\ ( heading at w + 1 ) - ( angle of {r}_{norm} ) \\ ( curvature at w + 1 ) \times ( modulus of {r}_{norm} ) \\ ( inflection at w + 1 ) \times {( modulus of {r}_{norm} )}^{2}\end{matrix} ] .$$
(c) determining a heading, a curvature, and an inflection of each interpolation point using the determined coefficients;
(d) determining the position of each interpolation point by substituting the determined coefficients into the polynomial;
(e) determining an error in position between the final interpolation point and waypoint w+1;
(f) assigning a new value to rₙₒrm to reduce the error, and
(g) repeating the process associated with (b)-(f) until a termination criterion is met.

13. The method according to claim 10, wherein the termination criterion includes a predetermined number of repetitions.

14. A system for controlling a vehicle, the system comprising:
a non-transitory computer-readable storage medium; and
a path controller operably coupled to the storage medium,
wherein the path controller is configured to obtain waypoint data for a series of waypoints from the storage medium and to determine interpolation point data for a series of interpolation points defining a target path for the vehicle by interpolating between the waypoints,
wherein the path controller is configured to control the vehicle such that the vehicle follows the target path,
wherein:
(a) the waypoint data includes position data and at least one of heading data, curvature data, and/or inflection data,
or
(b) the waypoint data includes the position data and the method includes using the path controller to determine, using the waypoint data, the at least one of the heading data, the curvature data, and/or the inflection data,
and
wherein the curvature data represents the heading data differentiated with respect to distance travelled and the inflection data represents the curvature data differentiated with respect to the distance travelled.

15. A computer program product or computer-readable storage medium comprising instructions which, when executed by a computer, cause the computer to carry out a method comprising:
providing waypoint data for a series of waypoints to a path controller;
using the path controller to determine interpolation point data for a series of interpolation points defining a target path for the vehicle by interpolating between the waypoints; and
controlling the vehicle such that the vehicle follows the target path,
wherein:
(a) the waypoint data includes position data and at least one of heading data, curvature data, and/or inflection data,
or
(b) the waypoint data includes the position data and the method includes using the path controller to determine, using the waypoint data, the at least one of the heading data, the curvature data, and/or the inflection data,
and
wherein the curvature data represents the heading data differentiated with respect to distance travelled and the inflection data represents the curvature data differentiated with respect to the distance travelled.
